(19) United States
(12) Patent Application Publication
(10) Pub. No.: US 2008/0158696 A1
(43) Pub. Date: Jul. 3, 2008

(54) Handheld magnifier with releasable magnifying lens

(76) Inventors: Gin Fai Yip, North Point (HK); Bryan Yip, Kowloon (HK); Richard Cameron, Syosset, NY (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/646,790

(22) Filed: Dec. 28, 2006

(51) Int. Cl. G02B 7/02

(52) U.S. Cl. 359/811

(57) ABSTRACT

A handheld magnifier comprising a handle; a magnifying lens; and a coupler for releaseably coupling the magnifying lens to the handle; wherein the coupler is coupled to the magnifying lens and comprises at least a first finger and a second finger; and the handle has a first receptacle for receiving the first finger of the coupler and a second receptacle for receiving the second finger of the coupler; wherein the fingers and the receptacles are coordinatingly configured so that the coupler is insertable into the handle when oriented such that the first finger is alignable with and insertable into the first receptacle and the second finger is alignable with and insertable into the second receptacle; and the first finger is not insertable into the second receptacle and/or the second finger is not insertable into the first receptacle.

### BACKGROUND OF THE INVENTION

The present invention relates generally to magnifiers, and in particular, to a handheld magnifier that comprises a handle and one or more magnifying lenses that can be coupled thereto, wherein the magnifying lens is insertable and/or releaseably securable to the handle only when particularly oriented with respect to the handle. In this way, optimized use of the magnifier is assured by proper orientation of the magnifying lens relative to the handle.

Magnifiers or magnifier sets that provide for interchangeable or releaseable magnifying lenses are known.

For example, existing in the prior art is a set of multi-use, connectable, clip-on magnifying lenses sold under the Carson and Connectables brandnames. Such lenses advantageously can be clipped-on almost any medical, cosmetic or craft tool. A cleverly designed mount and elongated extension ensure easy connecting and use.

U.S. Pat. No. 4,764,958 describes a telephone magnifier attachment in which an engagement means has secured thereto a frame having a lens therein. A socket is provided with an opening for receiving flexible projections on the frame. As described in the '958 patent, the flexible projections may be bent inwardly slightly during insertion into the opening. The opening includes a slot such that when the projections are inserted into the opening, retaining tips which extend outwardly from the flexible projections will engage the slot to prevent removal of the flexible projections. The frame/lens is also described and illustrated as being able to rotate relative to the socket, although the specification appears to make clear that such rotation is provided by rotating the frame until the flexible projections are engaged in a first pair of opposed corners of the rectangular opening.

It is believed that still further developments in the art are both desirable and achievable. For example, the symmetry in the construction of the aforementioned embodiments, as exemplified in the '958 patent, makes it clear that there are multiple (e.g. at least two (2)) positions in which the frame/lens can be inserted into the socket. Such “flexibility” of insertion and orientation of the lens, while in some applications may be advantageous, in situations, for example, where the characteristics of the magnifying lens requires a particular orientation, such “flexibility” is less than desirable, for example, in handheld magnifiers having multiple lenses, there will be a “preferred” side that, when viewed therethrough, will function best optically. However, there are additional advantages of a handheld magnifier that ensures a particularly oriented lens. For example, there may be aesthetic reasons for having the lenses insertable only in a particular orientation. For example, cosmetically a handle and lens attachment may be configured to be aligned to provide the best aesthetic look of the handheld magnifier. Lastly, it is believed that there will be fewer manufacturing obstacles or problems to overcome with a construction as provided herein.

Thus, it is believed that further advances in the art are desirable. For example, it would be desirable and advantageous to provide a handheld magnifier in which a particular orientation of a releasable magnifying lens is easily ensured. It is believed that the present invention overcomes the aforementioned deficiencies and achieves the aforementioned and below mentioned objectives.

### SUMMARY AND OBJECTIVES OF THE PRESENT INVENTION

It is thus an objective of the present invention to overcome the perceived deficiencies in the prior art.

For example, it is an objective of the present invention to provide an improved handheld magnifier in which orientation of a releasable magnifying lens is easily ensured.

Another objective of the present invention is to provide an improved handheld magnifier in which multiple magnifying lenses can be releaseably secured to the handle, thereby providing interchangeability of the magnifying lens.

Yet another objective of the present invention is to provide an improved handheld magnifier that ensures proper alignment of the magnifying lens, which can be easy to use.

As will be seen, the present invention is very advantageous in situations where the magnifying lens(es) may have specific characteristics which require, or where it is desirable to ensure, proper alignment thereof relative to the handle.

Still further, it is an objective of the present invention to provide a handheld magnifier that ensures a particularly oriented lens, for example, in embodiments having multiple lenses and in examples where aesthetic reasons may dictate a particular orientation of the lens.

Yet another objective of the present invention is to provide a handheld magnifier that is easier to manufacture, for example, and not limitation, by reducing the number or frequency of manufacturing obstacles or problems that would otherwise be needed to overcome.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

To overcome the perceived deficiencies in the prior art and to achieve the objects and advantages set forth above and below, the present invention is, generally speaking, directed to handheld magnifiers. In a first embodiment, the handheld magnifier preferably comprises a handle; a magnifying lens; and a coupler for releaseably coupling the magnifying lens to the handle; wherein the coupler is coupled to the magnifying lens and comprises at least a first finger and a second finger; and the handle has a first receptacle for receiving the first finger of the coupler and a second receptacle for receiving the second finger of the coupler; wherein the fingers and the receptacles are coordinatingly configured so that the coupler is insertable into the handle when oriented such that the first finger is alignable with and insertable into the first receptacle and the second finger is alignable with and insertable into the second receptacle; and the first finger is not insertable into the second receptacle and/or the second finger is not insertable into the first receptacle.

In a second embodiment, a handheld magnifier is provided and comprises a handle; a magnifying lens; and a coupler for releaseably coupling the magnifying lens to the handle; wherein the coupler is coupled to the magnifying lens and comprises at least a first finger and a second finger; and the handle has a first receptacle for receiving the first finger of the coupler and a second receptacle for receiving the second finger of the coupler; wherein the fingers and the receptacles are coordinatingly configured so that the coupler is insertable into the handle when oriented such that the first finger is alignable with and insertable into the first receptacle and the second finger is alignable with and insertable into the second receptacle; the first finger is releaseably lockable in the first receptacle and/or the second finger is releaseably lockable in the second receptacle; and the first finger is not lockable in the second receptacle and the second finger is not lockable in the first receptacle.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is a perspective view of a handheld magnifier constructed in accordance with the present invention;

FIG. 2 is a perspective view of the handheld magnifier of FIG. 1, shown with the magnifying lens disengaged from the handle;

FIG. 3 is a view taken about lines 3-3 in FIG. 2;

FIG. 4 is a view taken about lines 4-4 in FIG. 2;

FIG. 5 is yet another perspective view of the handheld magnifier of FIG. 1 showing particular features of the interior of the handle; and

FIG. 6 is an enlarged view of a portion of the handheld magnifier of FIG. 5.

Identical reference numerals in the figures are intended to indicate like parts, although not every feature in every figure may be called out with a reference numeral.

### DETAILED DESCRIPTION OF THE PREFERRED EMBODIMENTS

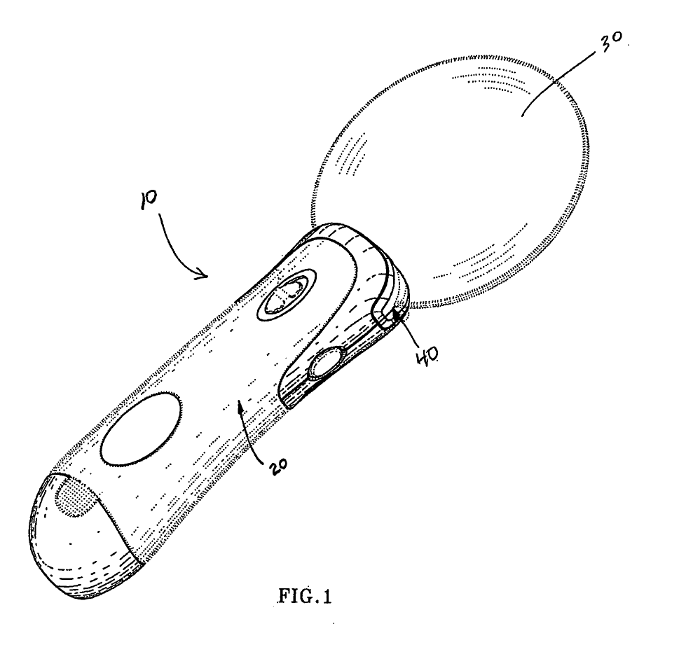

Reference is made to FIGS. 1-6, which illustrate a handheld magnifier, generally indicated at 10, constructed in accordance with the present invention.

In accordance with the present invention, handheld magnifier 10 comprises a handle generally indicated at 20, a magnifying lens 30 and a coupler, generally indicated at 40, for releaseably coupling magnifying lens 30 to handle 20.

Coupler 40 is preferably coupled to magnifying lens by a screw, friction fit, snap fit and/or some form of adhesive. Whether coupler and magnifying lens are releaseable from each other is not material to the scope of the invention. Preferably though, it is not intended that coupler 40 be easily decoupled from magnifying lens 30.

In the preferred embodiment, coupler 40 comprises at least a first finger 42 and a second finger 44. As illustrated in FIG. 3, first finger 42 is rectangular in shape and oriented parallel to the plane of magnifying lens 30. Contrasted with this is the orientation of second finger 44, which is also preferably rectangular in shape but oriented orthogonal to the plane of magnifying lens 30.

To receive fingers 42 and 44, handle 20 is preferably constructed with a first receptacle 22 for receiving first finger 42 of coupler 40 and a second receptacle 24 for receiving second finger 44 of coupler 40. As illustrated and in accordance with the present invention, fingers 42, 44 and receptacles 22, 24 are coordinatingly configured so that:

(i) coupler 40 is insertable into handle 20 when oriented in a first position such that first finger 42 is alignable with and insertable into first receptacle 22 and second finger 44 is alignable with and insertable into second receptacle 24; and

(ii) first finger 42 is not insertable into second receptacle 24 and/or second finger 44 is not insertable into first receptacle 22.

By “and/or” it is intended to mean that the objectives of the present invention are met if coupler 40 is not insertable into handle 20 when the magnifying lens (e.g. coupler 40) is turned over (e.g. flipped) and insertion is attempted. Clearly, this is achieved by one or more of the following:
a. only first finger 42 is not insertable in second receptacle 24;
b. only second finger 44 is not insertable in first receptacle 22; or
c. both first finger 42 is not insertable in second receptacle 24 and second finger 44 is not insertable in first receptacle 22.

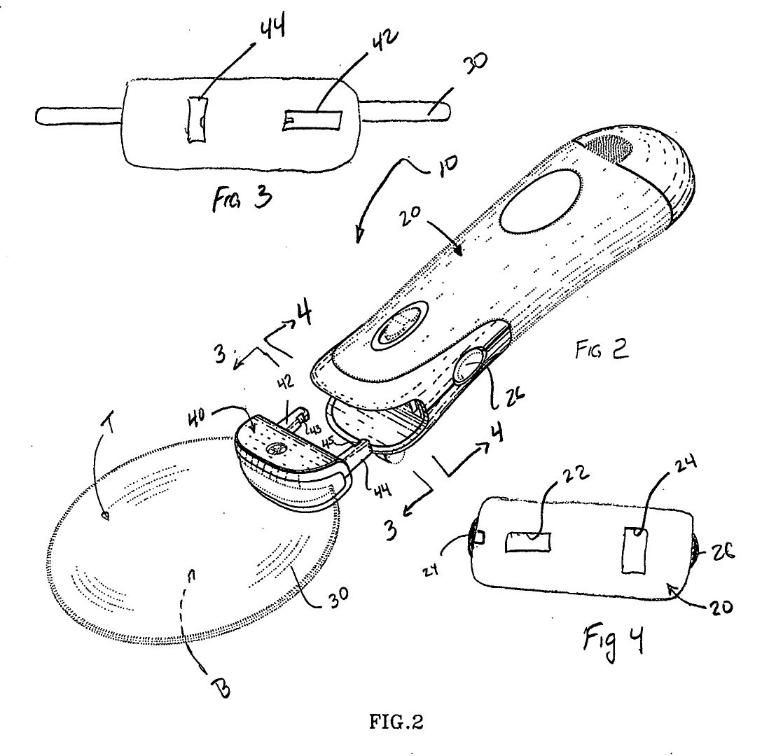

Clearly then, the “and/or” could be replaced with “at least one of” language should it be necessary or appropriate as it should be clear that as long as at least one of the fingers is not insertable in the “other” receptacle, objectives of the present invention are met. Moreover, by “first position,” it is meant that magnifier lens 30 is oriented for example as in FIG. 2. Any other position, such as a “second position” is intended to mean such that the “B” surface of magnifying lens 30 (as shown in FIG. 2) would be on top, as currently shown by the “T” surface in FIG. 2. In other words, the present invention is constructed such that magnifying lens 30 cannot be inserted upside down relative to the orientation of handle 20 as illustrated in FIG. 2.

FIGS. 3 and 4 illustrate exemplary shapes and orientations of fingers 42, 44 and receptacles 22, 24. However, this is by way of example and not limitation. For example, the finger shapes or orientation could be reversed and/or different. In fact, the shape of finger 42 could be rectangular, as but one example, while finger 44 is circular in cross-section, as but another example. Receptacles 22, 24 would then be correspondingly shaped to receive one, but not the other, finger. Again, in this way, a single insertion orientation of magnifying lens 30 (or more particularly, coupler 40) into handle 20 is ensured.

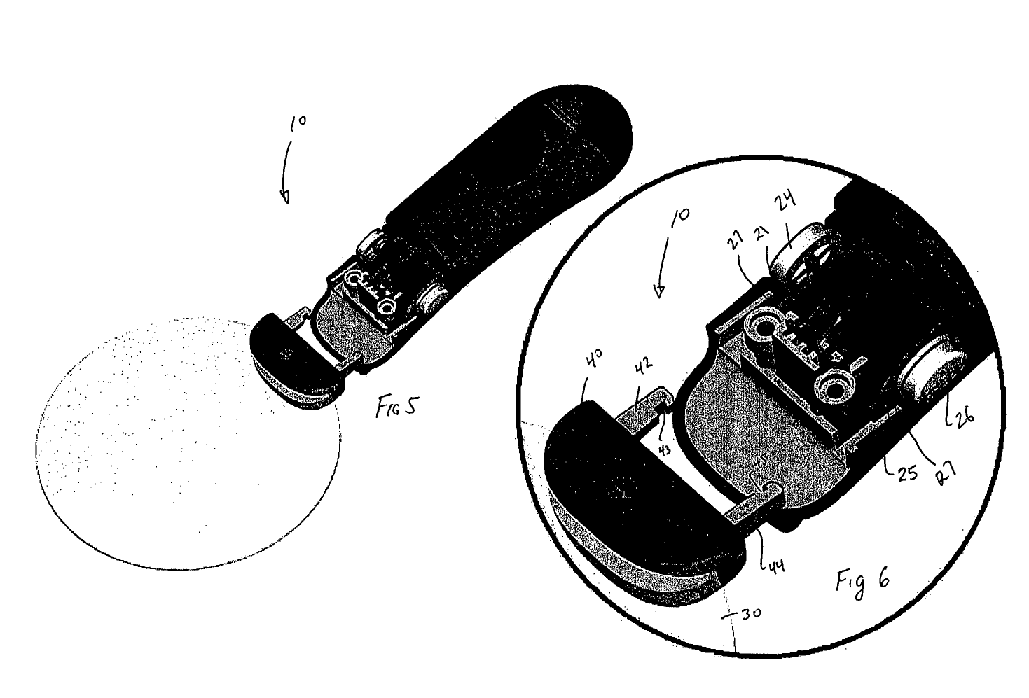

The preferred embodiment of the present invention provides locking means for engaging coupler 40 to handle 20 and for releasing the locking engagement of coupler 40 to handle 20, and reference may be made to FIGS. 5 and 6 for illustrations thereof. In a preferred embodiment, the locking means comprise hooks 25, 27 that are respectively engageable with notches in the fingers. For example, first finger 42 may include a notch 43 while second finger 44 may include a notch 45. As should be understood, only one notch 43/hook 27 (or notch 45/hook 25) combination would be needed to lock coupler 40 to handle 20, but providing a hook (e.g. 25, 27) associated with each finger ensures better locking thereof.

The locking means preferably also comprises a pusher on each side of handle 20 (e.g. pushers 24, 26) which apply pressure to respective internal (and flexible) arms 21, 23, which in turn disengages the respective hooks (27, 25) from notches 43 and/or 45. In this way, upon disengagement of the hook(s) with the notch(es), coupler 40 is removable from its coupling to the handle. FIGS. 5 and 6 illustrate how arms 21, 23 could be formed from a unitary flexible piece of material (e.g. plastic) or could be independent from each other.

Moreover, it is preferable that hooks 27, 25 are biased toward their respective receptacles so that the hooks are respectively biased towards notches 43, 45 in fingers 42 and 44, respectively, upon the insertion of the fingers into their respective receptacles.

Thus in the first embodiment, the present invention ensures the prevention of an (e.g.) upside down insertion of the coupler into the handle.

In another embodiment, fingers 42, 44 and the respective receptacles 22, 24 may be coordinatingly configured so that:

(i) coupler 40 is releaseably securable to handle 20 when oriented in a first position such that first finger 42 is alignable with and insertable into first receptacle 22 and second finger 44 is alignable with and insertable into second receptacle 24;

(ii) first finger 42 is releaseably lockable in first receptacle 22 and/or second finger 44 is releaseably lockable in second receptacle 24; and

(iii) first finger 42 is not lockable in second receptacle 24 and second finger 44 is not lockable in first receptacle 22.

Again, by “and/or” it is intended to mean that objectives of the present invention are met if at least one of the fingers is lockable in its respective receptacle when the magnifying lens is properly orientated relative to the handle. And, if magnifying lens (e.g. coupler 40) is attempted to be inserted while turned over (e.g. flipped), lockability is not possible. Such may be achieved for example, by providing only one hook (e.g. associated with receptacle 22) and only providing one finger (e.g. finger 42) with a notch. In this way, attempted insertion in the wrong direction ensures that the lockability of the coupler to the handle cannot be achieved and the user would therefore be prompted to invert the coupler prior to reinsertion in the handle. Clearly then, the “and/or” could be replaced with “at least one of” language should it be necessary or appropriate, as disclosed above.

In the preferred construction, handle 20 and coupler 40 are made of plastic.

It can thus be seen that the present invention is advantageous and overcomes the perceived deficiencies in the prior art. Most significantly, in situations where it is desirable to ensure the orientation of a releasable magnifying lens on a handheld magnifier of the type disclosed herein, the present invention is believed to be the first of its kind. As disclosed, where the orientation of the lens is important (e.g. for functional or aesthetic reasons, as disclosed above), the present invention ensures such orientation. Additionally, the present invention provides an improved handheld magnifier in which multiple magnifying lens can be releaseably secured to the handle, thereby providing interchangeability of the magnifying lens. Still further, all of the foregoing is provided in a handheld magnifier that is easy to use.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

It should also be understood that the following claims are intended to cover all of the generic and specific features of the invention described herein and all statements of the scope of the invention that as a matter of language might fall there between

What is claimed is:

1. A handheld magnifier comprising:
a handle;
a magnifying lens; and
a coupler for releasably coupling the magnifying lens to the handle;
wherein:
the coupler is coupled to the magnifying lens and comprises at least a first finger and a second finger; and
the handle has a first receptacle for receiving the first finger of the coupler and a second receptacle for receiving the second finger of the coupler;
wherein the fingers and the receptacles are coordinatingly configured so that:
the coupler is insertable into the handle when oriented such that the first finger is alignable with and insertable into the first receptacle and the second finger is alignable with and insertable into the second receptacle; and
the first finger is not insertable into the second receptacle and/or the second finger is not insertable into the first receptacle.

2. The handheld magnifier as claimed in claim 1, wherein the first finger is not insertable into the second receptacle and the second finger is not insertable into the first receptacle.

3. The handheld magnifier as claimed in claim 1, comprising locking means for engaging the coupler to the handle and for releasing the locking engagement of the coupler to the handle.

4. The handheld magnifier as claimed in claim 3, wherein the locking means comprises:
a hook that is engageable with a notch in the first finger; and
a pusher that causes the hook to disengage with the notch in the first finger;
whereby upon disengagement of the hook with the notch, the coupler is removable from its coupling to the handle.

5. The handheld magnifier as claimed in claim 4, wherein the hook is biased toward the first receptacle so that the hook is biased towards the notch in the first finger upon the insertion of the first finger into the first receptacle.

6. A handheld magnifier comprising:
a handle;
a magnifying lens; and
a coupler for releaseably coupling the magnifying lens to the handle;
wherein:
the coupler is coupled to the magnifying lens and comprises at least a first finger and a second finger; and
the handle has a first receptacle for receiving the first finger of the coupler and a second receptacle for receiving the second finger of the coupler;
wherein the fingers and the receptacles are coordinatingly configured so that:
the coupler is insertable into the handle when oriented such that the first finger is alignable with and insertable into the first receptacle and the second finger is alignable with and insertable into the second receptacle;
the first finger is releaseably lockable in the first receptacle and/or the second finger is releaseably lockable in the second receptacle; and
the first finger is not lockable in the second receptacle and the second finger is not lockable in the first receptacle.

7. The handheld magnifier as claimed in claim 6, wherein the first finger is releaseably lockable in the first receptacle and the second finger is releaseably lockable in the second receptacle.

8. A magnifier comprising:
a handle;
a magnifying lens having a first side and a second side;
a coupler for releaseably coupling the magnifying lens to the handle;
wherein the coupler is coupled to the magnifying lens and comprises orientation means and the handle has receptacle means for receiving the orientation means; and
wherein the orientation means and the receptacle means are coordinatingly configured so that:
the coupler is insertable into the handle only when oriented in a first position relative to the receptacle means such that the orientation means is alignable with and insertable into the receptacle means; and
there is no second position for which the orientation means is alignable and insertable into the receptacle means.

9. The handheld magnifier as claimed in claim 8, wherein the handle has a top and a bottom and wherein the magnifying lens has a top surface and a bottom surface and wherein the first position is such that the top surface of the magnifying lens is aligned with the top of the handle and the second position is such that it is attempted to align the top surface of the handle with the bottom surface of the magnifying lens.
